(19) United States
(12) Patent Application Publication
(10) Pub. No.: US 2006/0109760 A1
(43) Pub. Date: May 25, 2006

(54) System and device for audio visual information transfer and storage

(76) Inventor: Gerald Seelig, Des Plaines, IL (US)

Correspondence Address: THE INVENTORS NETWORK, INC., 332 ACADEMY STREET, CARNEGIE, PA, 15106, US

(21) Appl. No.: 10/992,986

(22) Filed: Nov. 22, 2004

(51) Int. Cl. G11B 5/09

(52) U.S. Cl. 369/47.12; 369/84

(57) ABSTRACT

A device that incorporates video cassette, audio cassette, CD and DVD record, play and copy functions includes at least one video cassette tape slot, one audio cassette tape slot, and at least one CD/DVD slot so that information and data on a video cassette tape can be transferred and copied to a DVD disc, and information and data stored on an audio cassette tape can be transferred and copied to a CD by inserting each particular medium into the appropriate slot and then activating a copy button or switch for transferring the data and information to the new storage and play medium.

### FIELD OF THE INVENTION

The present invention pertains to information and data transfer and storage systems, and more particularly pertains to a device for transferring and copying data and information from one medium to a second medium.

### BACKGROUND OF THE INVENTION

While optically readable disc-shaped information media, such as cd-roms and DVDs, dominate the market, individuals, institutions, agencies, and businesses still utilize the older tape cassettes, both video and audio, for everything from company training, safety and sales presentations to the storage and playing of motion picture films and documentaries. However, the use of audio and video tape cassettes as media to store information has a number of drawbacks. Tape cassettes are brittle and can easily rip or tear thus making the tape inoperable for running through the read, record and play heads of the audio and video cassettes. In addition, video cassettes tapes are quite bulky and as the video cassette tape collection, library or archive grows, there is a consequent diminishing of space, whether in a home, office or storage room. It is not uncommon for homes and offices to accumulate thousands of video cassette tapes. Thus, it is desirable to transfer and copy the information and data contained on audio and video tape cassettes to other media, most notably the optically readable disc-shaped information technology.

A primary advantage of laser beam technology in the playback of audio and visual images, information and data is the high quality of repeated playback without degradation due to the fact that the media need not be in contact with the means—the red or blue laser beam—that is used to read the media during playback. Thus, it is preferable to use laser disc technology to store audio and visual data and information. Laser beam technology is more durable and stable, and achieves a much higher fidelity in repeated playbacks. The prior art discloses a variety of processes and devices for converting, transferring and copying information and data among the various types of information technology.

For example, the Tokumaka patent (U.S. Pat. No. 4,580,174) discloses an apparatus for recording and/or reproducing video and audio signals that includes a number of frequency modulators for modulating and mixing both audio and visual signals.

The Bluthgen patent (U.S. Pat. No. 4,750,173) discloses a method of transmitting audio information wherein bits are replaced according in a predetermined manner for properly encoding audio information.

The Higurashi patent (U.S. Pat. No. 4,752,832) discloses a video and audio signal recording and/or reproducing apparatus that includes an interconnected series of blocks and decoders for obtaining the reproduced video signal.

The Sturm et al. patent (U.S. Pat. No. 5,260,800) discloses an apparatus and method for high-speed video tape duplication wherein the duplication occurs at a speed that is twice the normal playback speed from a laser disk master to a video cassette.

The Kim et al. patent (U.S. Pat. No. 5,946,442) discloses a high-speed video tape copier for rapidly copying a video signal from one video tape to another video tape.

The Lemke et al. patent (U.S. Pat. No. 6,393,199 B1) discloses an apparatus and method for high speed recording of video signals that includes a helical scan tape recorder capable of recording video cassettes and audio cassettes at up to 40 times their normal playback speed.

Nonetheless, despite the ingenuity of the above devices, there remains a need for a single device that allows an individual to transfer and copy information and data among various types of storage media so that the overall size of the individual's music and video collection or library can be reduced while at the same time enhancing the playback ability and longevity of such a collection or library.

### SUMMARY OF THE INVENTION

The present invention comprehends an electronic device for transferring and writing data and information among various types of storage and play media that include audiocassette tapes, video cassette tapes, CD (compact disc) and DVD discs so that the size of one's music and film collection or library can be reduced in size and bulk and preserved in more durable, longer-lasting format.

The present invention includes a device that incorporates features and functions for recording, playing and, most significantly, transferring and copying information and data contained on less durable and long lasting media to more durable, long lasting media. Thus, the device includes at least one port or slot for a video cassette tape, at least one port or slot for an audio cassette tape, and one port or slot for a CD/DVD disc. The device includes a copy selection switch or button for selecting the between the two modes of media copying: 1. from video cassette tape to DVD disc; or 2. from audio cassette tape to a CD. A separate switch or button is actuated for transferring and copying data and information contained on the video cassette tape or audio cassette tape to, respectively, the DVD disc or the CD.

It is an objective of the present invention to provide a system and device for the transfer and storage of information and data contained on one medium to another medium so that music, film, and movies are stored on a more durable storage medium.

It is another objective of the present invention to provide a system and device for the transfer and storage of information and data contained on one medium to another medium whose storage and playback qualities are longer lasting than the original medium.

It is yet another objective of the present invention to provide a system and device for the transfer and storage of information and data contained on one medium to another medium that will save space by eliminating the need for using video cassette tapes as the original storage medium.

It is still yet another objective of the present invention to provide a system and device for the transfer and storage of information and data contained on one medium to another medium that will save room and space by transferring information and data on audio cassettes to a less fragile and less bulky storage and play medium.

Still yet another objective of the present invention is to provide a system and device for the transfer and storage of information and data to CDs and DVD discs thereby reducing in size and economizing in space the size of one's music and film collection.

These and other objects, features and advantages will become apparent to one skilled in the art upon a perusal of the following detailed description read in conjunction with the accompanying drawing figures.

### BRIEF DESCRIPTION OF THE DRAWING FIGURES.

FIG. 1 is a perspective view of the combination record, transfer and play device for transferring information and data stored on one medium to a second medium;

FIG. 2 is a perspective view of the combination record, transfer and play device showing the various media, such as a video cassette tape, an audio cassette tape, and a CD, among which data and information can be transferred and stored; and

FIG. 3 is a schematic flowchart illustrating the primary steps for transferring information and data from a video cassette tape or audio cassette tape to a CD or DVD disc.

### DETAILED DESCRIPTION OF THE PREFERRED EMBODIMENT

Illustrated in FIGS. 1-3 is a system and device 10 for transferring and copying information and data from one type of information technology medium to a second information technology medium that is more durable, long-lasting and obtains a much higher fidelity and quality in repeated playbacks of the information and data such as audio and visual images and scenes.

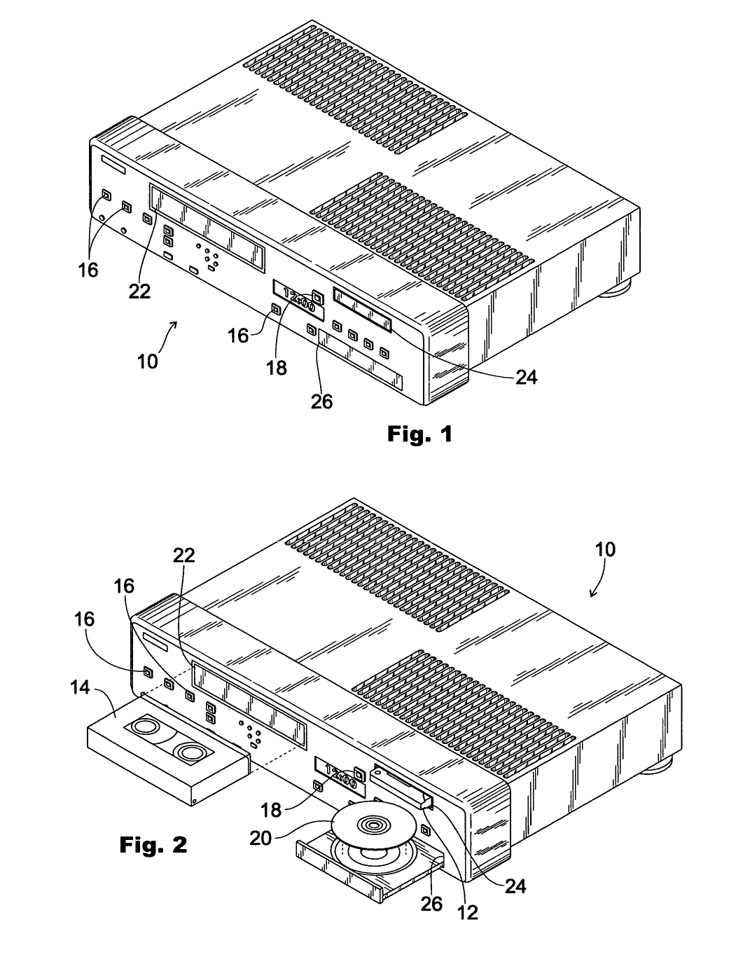

The record, copy and playback device 10 is similar to any of a number of different brands of combination radio, cassette, CD/DVD players manufactured and sold by such companies as Sony, Panasonic, or JVC. The device 10 of the present invention is designed to transfer and copy information and data from an audio cassette tape 12 and video cassette tape 14 to more durable and long-lasting playable media. As shown in FIGS. 1 and 2 the device 10 includes the standard switches and buttons 16 for activating and controlling such standard functions as record, play, pause, stop, forward, fast forward, reverse, and eject. The device 10 also includes a copy button 18 that serves a dual purpose in actuating the copying of information and data (sound and images) contained on either the audio cassette tape 12 or the video cassette tape 14 to, respectively, a blank CD or a DVD disc 20. Thus, the device 10 includes at least one port or slot 22 for receiving the video cassette tape 14 and at least one port or slot 24 for receiving the audio cassette tape 12. In addition, the device 10 includes at least one port or slot 26 for receiving the CD/DVD disc 20.

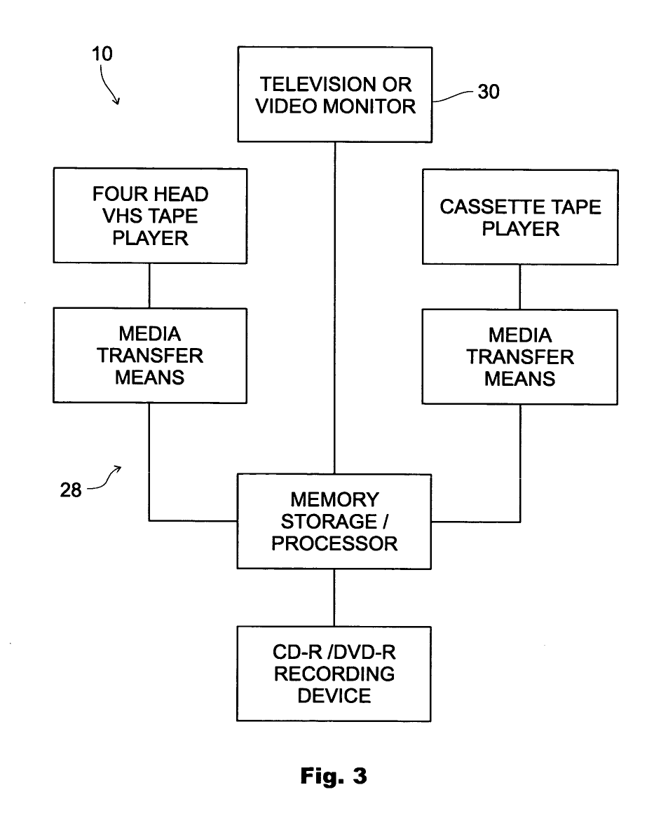

As shown in FIGS. 1-3, in order to transfer and copy the information and data contained on the audio cassette tape 12, the individual first loads the audio cassette tape 12 into the appropriate slot 24, and then loads the CD 20 into the appropriate slot 26. The individual then presses the copy button 18 for activating the device 10 to transfer and copy all the music and lyrics of the songs on the audio cassette tape 12 to the CD 20. In order to transfer and copy information and data contained on the video cassette tape 14, the individual first loads the video cassette tape 14 into the into the appropriate slot 22, and then loads the blank DVD disc into the appropriate slot 26. The individual then presses the copy button 18 to activate the device 10 to transfer and copy the contents of the video cassette tape 14 onto the DVD disc. The flowchart 28 of FIG. 3 schematically illustrates the actual device processing steps for accomplishing the media transfer and copying. After the copying the CD or DVD 20 becomes a read only media disc and can be ejected from the device 10 for proper storage. It should be noted that all the necessary electrical interconnections between the device 10 and the television set or video monitor 30, and with the coaxial cables coming into the dwelling would have already been made.

By taking the above steps an individual or a business can gradually reduce their bulky collection and storage of video cassette tapes 14 and audio cassettes tapes 12 too much more manageable, storable, sturdier, durable and long lasting CDs and DVDs.

The above description pertains to a preferred embodiment of the present invention; and it will be apparent to those skilled in the art that numerous modifications, alterations, and variations will be possible and practicable without departing from the spirit of the invention or the scope of the appended claims.

I claim:

1. An information transfer and copying device for copying information contained on one information technology medium to another information technology medium, comprising:
at least one slot for loading therein one video cassette tape;
at least one slot for loading therein one audio cassette tape;
at least one slot for loading therein either a CD or a DVD disc;
a dual use copy button for selectively actuating the transfer and copying of information from one information technology medium another information technology medium that have been both loaded into the appropriate slots; and
actuation of the dual copy button initiates the transfer and copy of information contained on the video cassette tape to the DVD disc or the transfer and copy of information contained on the audio cassette tape to the CD disc.

2. A method of transferring and copying information contained on one information technology medium to another technology medium, comprising the steps of:
loading one video cassette tape into the appropriate slot of an information transfer and copying device;
loading one DVD disc into the appropriate slot of the information transfer and copying device; and
actuating a copy button on the device for initiating the transfer and copying of the information contained on the video cassette tape to the DVD disc.

3. A method of transferring and copying information contained on one information technology medium to another technology medium, comprising the steps of:
loading one audio cassette tape into the appropriate slot of an information transfer and copying device;
loading one CD disc into the appropriate slot of the information transfer and copying device; and
actuating a copy button on the device for initiating the transfer and copying of the information contained on the audio cassette tape to the CD disc.
